(19) United States
(12) Patent Application Publication
(10) Pub. No.: US 2014/0222813 A1
(43) Pub. Date: Aug. 7, 2014

(54) COLLECTING DATA IN INTERNET OF THINGS

(71) Applicant: EMC Corporation, Hopkinton, MA (US)

(72) Inventors: Ziye Yang, Shanghai (CN); Xi Chen, Shanghai (CN); Bo Huang, Shanghai (CN); Qiang Zou, Shanghai (CN); Kai Huang, Shanghai (CN)

(73) Assignee: EMC Corporation, Hopkinton, MA (US)

(21) Appl. No.: 14/173,105

(22) Filed: Feb. 5, 2014

(30) Foreign Application Priority Data
Feb. 7, 2013 (CN) CN201310060863.3

(51) Int. Cl. G06F 17/30

(52) U.S. Cl. CPC G06F 17/30861
USPC 707/736

(57) ABSTRACT

Embodiments of the present invention relate to a method, apparatus and system for collecting data in an Internet of Things. In one embodiment of the present invention, there is provided a method for collecting data in an Internet of Things, comprising: receiving status data from a sensor node of at least one sensor node; in response to verifying the status data being trusted status data, extracting content data from the status data; aggregating the content data based on a predefined rule; and transmitting the aggregated content data to a data center; wherein the at least one sensor node is connected with the data center via the Internet of Things. In one embodiment, there is provided an apparatus for collecting data in an Internet of Things. In one embodiment, there is provided a system for collecting data in an Internet of Things.

### RELATED APPLICATION

This Application claims priority from Chinese Patent Application Serial No. CN201310060863.3 filed on Feb. 7, 2013 entitled “METHOD, APPARATUS AND SYSTEM FOR COLLECTING DATA IN INTERNET OF THINGS,” the content and teachings of which are hereby incorporated by reference in their entirety.

### FIELD

Embodiments of the present invention relate to data collection, and more specifically, to a method, computer program product, apparatus and system for collecting data in an Internet of Things (IoT).

### BACKGROUND

The development of the Internet of Things (IoT) brings about convenience to the work and life of people, and moreover, IoT has become a significant factor in influencing the life of people. For example, a large number of sensors may be deployed in an IoT to monitor and collect various kinds of data from the real world. In another example, concerning IoT for monitoring traffic conditions, cameras/video cameras may be deployed at certain predestined locations to monitor road conditions; and in a further example in an IoT for monitoring transmission lines, sensors may be deployed along transmission lines to monitor various parameters (e.g., temperature, humidity, atmospheric pressure, and wind force). Again, in an IoT for monitoring building security, cameras/video cameras may be disposed at entrances and other places of a building to monitor movement of objects such as people or goods, and further card readers may be deployed to read identity information of those objects, etc.

Data collected by these sensors are subsequently transmitted via communication nodes in an IoT, for example, to a data center, for further processing. As IoT usually relates to the security assurance of various industries, maintaining security of IoT itself becomes critical.

Sensors in an IoT are typically distributed in a relative open environment. For example, sensors for monitoring transmission lines might be distributed in a mountainous region or other places that may not be easily accessible to humans. As it becomes harder to separately monitor, for example, the security conditions of each sensor, people with malicious intentions, such as hackers, might possibly destroy the sensor by changing the hardware of the sensors or modifying the software configuration of sensors; leading to a situations, wherein information transmitted via the IoT might be incorrect or fallacious. As a consequence, sensors in the IoT will not reflect the real status of monitored objects, which affects the judgment or decision of administrators in the data center and can result for example in transmission line failures.

On the other hand, as there are numerous sensors in an IoT collecting data at high frequency (for example may be once or many times per second), and the total amount of data collected from various sensors within a specific time period might be relatively large. In addition to the security problem as detailed above, another problem confronting IoT is with respect to transmission of the high volumes of data collected to a data center in real time (or in approximately real time).

### SUMMARY

Therefore, it is desired to develop and implement a technical solution capable of collecting data in an Internet of Things, and it is desired that the technical solution can be implemented without changing the hardware configuration of infrastructures of the existing Internet of Things as far as possible. In addition, while desiring the technical solution can enhance the security of sensors in the Internet of Things, it is desired the technical solution can enhance the security during transmitting data via communication nodes in the Internet of Things and further prevent potential risks in data source and data transmission respects. On the other hand, it is further desired the technical solution can, without decreasing the collecting frequency, reduce the load of data traffic in the Internet of Things as much as possible and further prevent possible network congestion and improve the efficiency of data transmission.

In one embodiment of the present invention, there is provided a method for collecting data in an Internet of Things, comprising: receiving status data from a sensor node of at least one sensor node; in response to verifying the status data being trusted status data, extracting content data from the status data; aggregating the content data based on a predefined rule; and transmitting the aggregated content data to a data center; wherein the at least one sensor node is connected with the data center via the Internet of Things.

In one embodiment of the present invention, the verifying the status data being trusted status data comprises: interpreting identification information in the status data; and in response to the identification information indicating the sensor node is an authenticated device, verifying the status data being trusted status data.

In one embodiment of the present invention, the verifying the status data being trusted status data further comprises: interpreting signature information in the status data; and in response to the signature information indicating the status data having not been modified during transmission, verifying the status data being trusted status data.

In one embodiment of the present invention, there is provided an apparatus for collecting data in an Internet of Things, comprising: a receiving module configured to receive status data from a sensor node of at least one sensor node; an extracting module configured to, in response to verifying the status data being trusted status data, extract content data from the status data; an aggregating module configured to aggregate the content data based on a predefined rule; and a transmitting module configured to transmit the aggregated content data to a data center; wherein the at least one sensor node is connected with the data center via the Internet of Things.

In one embodiment of the present invention, the extracting module comprises: a first interpreting module configured to interpret identification information in the status data; and a first verifying module configured to, in response to the identification information indicating the sensor node is an authenticated device, verify the status data being trusted status data.

In one embodiment of the present invention, the extracting module further comprises: a second interpreting module configured to interpret signature information in the status data; and a second verifying module configured to, in response to the signature information indicating the status data having not been modified during transmission, verify the status data being trusted status data.

In one embodiment of the present invention, there is provided a system for collecting data in an Internet of Things, comprising: at least one sensor node configured to collect status data in the Internet of Things; a data center configured to manage the Internet of Things; and a middle node configured to: receive the status data from a sensor node of the at least one sensor node; in response to verifying the status data being trusted status data, extract content data from the status data; aggregate the content data based on a predefined rule; and transmit the aggregated content data to the data center; wherein the at least one sensor node is connected with the data center via the middle node.

The method, apparatus and system for collecting data in an Internet of Things as provided according to various embodiments of the present invention can be conveniently implemented in the existing Internet of Things architecture, and administrators in the data center can use commands to modify various configurations of sensors and communication nodes without changing hardware devices.

### BRIEF DESCRIPTION OF THE SEVERAL VIEWS OF THE DRAWINGS

Through the more detailed description below in conjunction with the accompanying drawings, the features, advantages and other aspects of the embodiments of the present invention will become more apparent. Several embodiments of the present invention are illustrated schematically and are not intended to limit the present invention. In the drawings:

FIG. 1 schematically illustrates an architectural diagram of an Internet of Things according to one solution;

FIG. 2 schematically illustrates an architectural diagram of an Internet of Things according to one embodiment of the present invention;

FIG. 3 schematically illustrates a flowchart of a method for collecting data in an Internet of Things according to one embodiment of the present invention;

FIGS. 4A and 4B schematically illustrate block diagrams of a middle node and a sensor node in an Internet of Things according to one embodiment of the present invention, respectively;

FIG. 5 schematically illustrates a schematic view of the data structure of status data according to one embodiment of the present invention;

FIG. 6 schematically illustrates a flowchart of collecting data in an Internet of Things according to one embodiment of the present invention; and

FIG. 7 schematically illustrates a schematic view of an apparatus for collecting data in an Internet of Things according to one embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or one embodiment combining software and hardware aspects that may all generally be referred to herein as a “circuit,” “module” or “system.” Furthermore, in some embodiments, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated data signal may take any of a variety of forms, including, but not limited to, an electro-magnetic signal, optical signal, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instruction means which implements the function/act specified in the flowchart and/or block diagram block or blocks.

The computer program instructions may also be loaded onto a computer, other programmable data processing apparatus, or other devices to cause a series of operational steps to be performed on the computer, other programmable data processing apparatus or other devices to produce a computer implemented process such that the instructions which execute on the computer or other programmable apparatus provide processes for implementing the functions/acts specified in the flowchart and/or block diagram block or blocks.

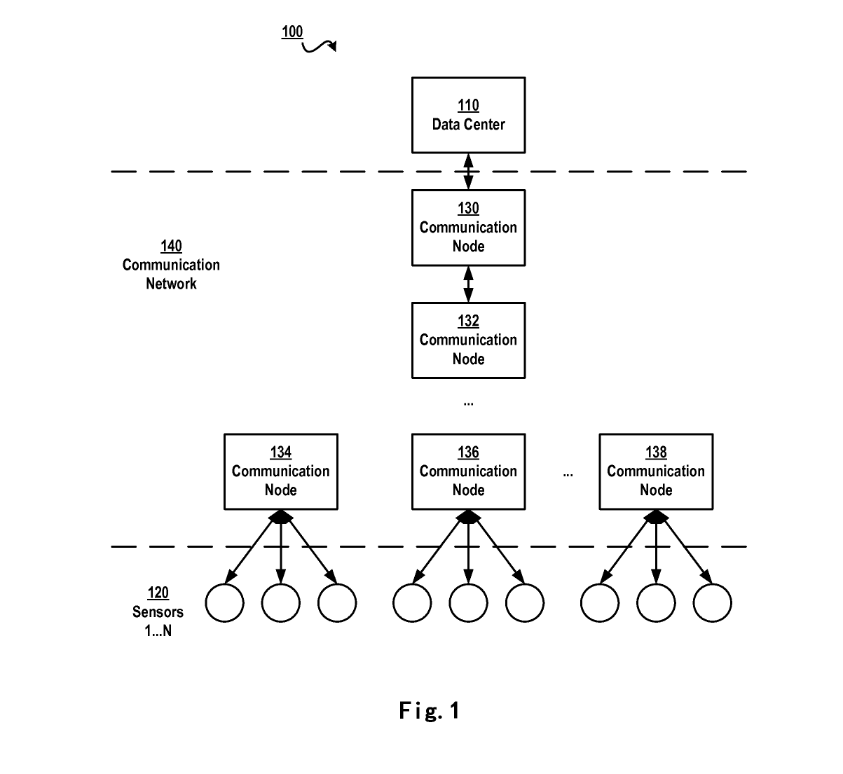

FIG. 1 schematically illustrates an architecture diagram 100 of an Internet of Things according to one solution. As illustrated in FIG. 1, generally the Internet of Things may comprise three portions: a data center 100, serving as a control center of the entire Internet of Things and for managing and controlling operations at various nodes in the Internet of Things; sensors 120 (e.g., may comprise N sensors 120-1, . . . , 120-N), for collecting status data (e.g., meteorological data such as temperature, humidity, atmospheric pressure and wind force) of monitored objects; and a communication network 140, e.g., comprising a plurality of communication nodes 130, . . . , 138 (e.g., switches, routers, etc.).

Note in the solution according to the prior art, the communication network in the Internet of Things is merely used for receiving and forwarding to the data center data collected by sensors. As sensors usually collect data with high frequency (e.g., once per minute or second, and even higher frequency), when the number of sensors reaches certain orders of magnitude, the amount of data collected by all sensors is amazingly huge. In addition, when forwarding data at communication nodes 130, . . . , 138 in the communication network 140, received data is subjected to operations such as packaging, and these operations further increase the amount of data to be transmitted via the network. On the other hand, sensors 120 are equipped with only simple physical protective measures or even no protective measures, when sensors 120 themselves or software programs running on them are revised, the security of monitored data is likely to be undermined.

In view of the above problems, the present invention proposes a method, apparatus and system for collecting data as implemented based on the existing architecture of an Internet of Things. In the modern Internet of Things, devices serving as communication nodes 130, . . . , 138 may be, for example, routers or switches, etc. These devices are equipped with certain data processing capabilities and storage space. However, the prior art communication nodes merely perform some simple operations like data packaging and forwarding. On the one hand, this results in excessive data packets transmitted in the Internet of Things; on the other hand, data processing capabilities and storage space of communication nodes are not put into full use, which causes a waste of resources in communication nodes.

Based on the basic configuration of communication nodes in the current Internet of Things, one embodiment of the present invention provides an improved technical solution, which uses idle data processing capabilities and storage space of communication nodes to pre-process raw data collected by sensor nodes and further transmit the pre-processed data via the Internet of Things. In this manner, the load of data traffic in the Internet of Things can be reduced greatly; on the other hand, the data center no longer has to process, one by one, status data collected at various time points by each sensor node, so that the data center can focus on post analysis and processing operations more efficiently.

In addition, to improve the security of sensor nodes, various embodiments of the present invention provide a technical solution of verifying the reliability of sensor nodes to provide a reliable data source. Note sensor nodes usually have certain capabilities of data processing, data storage and networking. Thus, these capabilities in sensor nodes may be leveraged to provide a mechanism for verifying the reliability of sensor nodes.

Those skilled in the art should note in a modern Internet of Things environment, although sensor devices and devices in a communication network have certain data processing capabilities, these data processing capabilities are not put into reasonable application. In security respect, there also lacks an efficient solution of how to ensure each sensor node is secure and reliable.

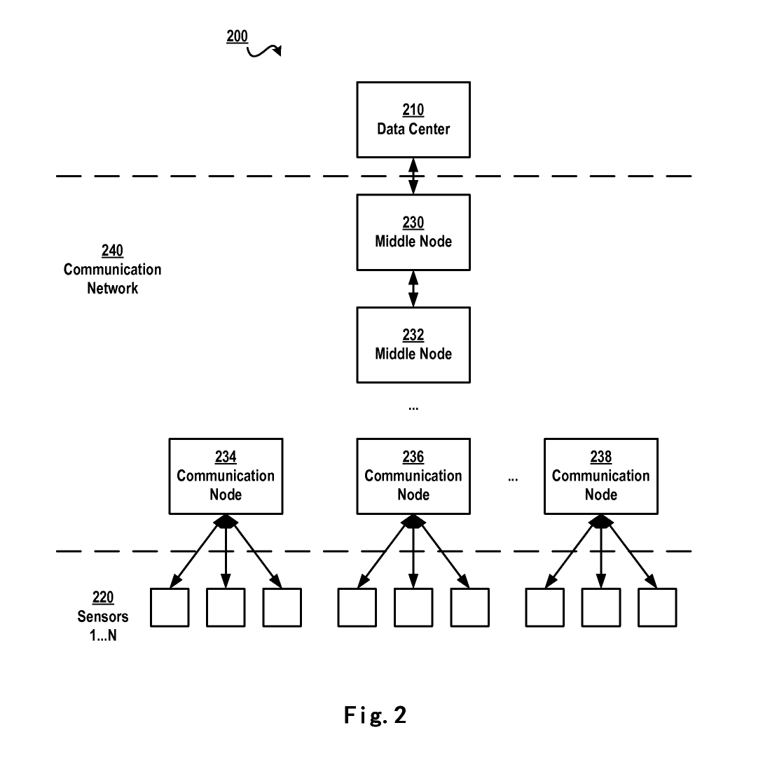

Specifically, FIG. 2 schematically illustrates an architectural diagram 200 of an Internet of Things according to one embodiment of the present invention. The architecture of the Internet of Things illustrated in FIG. 2 is similar to the schematic diagram of FIG. 1; what is different is that middle nodes 230 and 232 near the data center level in a communication network 240 may be communication nodes having a pre-processing capability and a forwarding capability. Note various nodes in the Internet of Things from a data center 210 to sensor nodes 220 may be connected in the form of a tree structure, wherein data center 210 is located at a root node while sensors 220 are located at leaf nodes. As data being collected is transmitted upwards to the data center 210 at the root node through each level, the closer to the root node a node is, the higher the traffic load is; on the contrary, the closer to a leaf node a node is, the lower the traffic load is.

Thus, it is possible to adjust the function of communication nodes near the root node to make them become middle nodes that support forwarding and pre-processing functions. Specifically, considering that the closer to data center 210 a communication node is, the more sufficient various resources are, communication nodes at a distance of 1 “hop” or 2 “hop” from data center 210 may be configured as middle nodes that support forwarding and pre-processing functions, and functions of other communication nodes in communication network 240 are kept unchanged. In this manner, it is possible to make full use of idle data processing resources of nodes at higher levels in the Internet of Things and transfer tasks that used to be executed by the data center to devices in the Internet of Things; on the other hand, it is possible to reduce the load of data traffic in the Internet of Things and further improve the transmission efficiency.

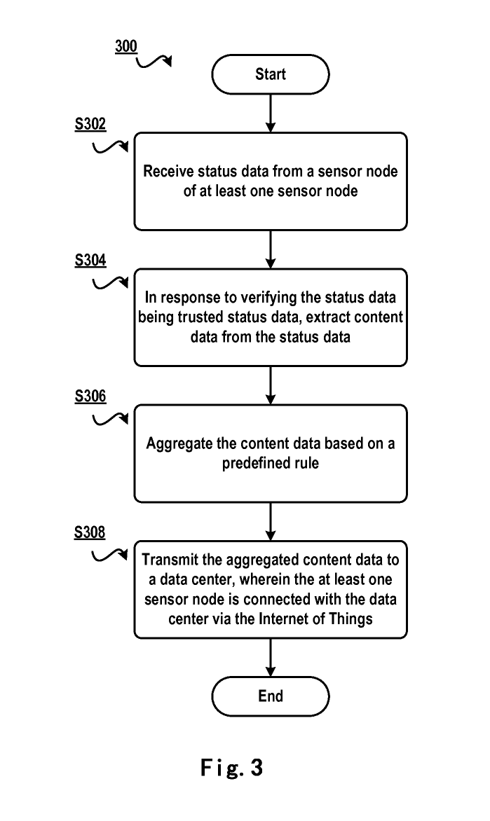

FIG. 3 schematically illustrates a flowchart 300 of a method for collecting data in an Internet of Things according to one embodiment of the present invention. Specifically, FIG. 3 illustrates a method for collecting data in an Internet of Things, comprising: receiving status data from a sensor node of at least one sensor node; in response to verifying the status data being trusted status data, extracting content data from the status data; aggregating the content data based on a predefined rule; and transmitting the aggregated content data to a data center; wherein the at least one sensor node is connected with the data center via the Internet of Things.

First of all, status data from a sensor node of at least one sensor node is received in step S302. In this embodiment, the status data may comprise data (e.g., temperature, humidity, atmospheric pressure, etc.) of monitored objects as collected by sensor nodes in the Internet of Things. In addition, for the purpose of improving security, the status data may further comprise other data, such as data headers for packaging data, identifiers for indicating sensor nodes, etc. In the context of the present invention, illustration is given to concrete content of collected data by only taking sensors for monitoring meteorological elements (e.g., temperature, humidity, atmospheric pressure) as an example. Suppose sensors are configured to measure temperature, humidity and atmospheric pressure every one hour. Table 1 illustrates below values of meteorological elements that have been collected within a certain time range.

TABLE 1
Collected Data

| | | Temperature | Humidity | Atmospheric |
|---|---|---|---|---|
| No. | Time | (° C.) | (%) | Pressure (kPa) |
| 1 | 2013-01-01-0800 | 4 | 50 | 101 |
| 2 | 2013-01-01-0900 | 5 | 48 | 100 |
| 3 | 2013-01-01-1000 | 5.5 | 45 | 102 |
| . . . | . . . | . . . | . . . | . . . |

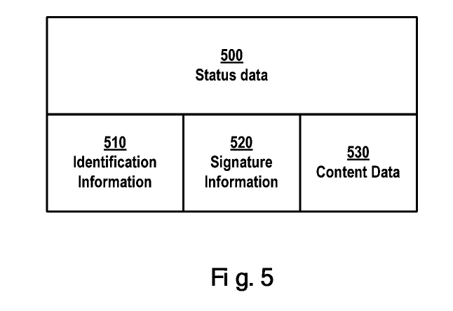

Data as illustrated in Table 1 above may be transmitted to the data center via the Internet of Things subsequent to being packaged into the status data. In addition, the status data may further comprise other content, which will be described in detail with reference to FIG. 5 below.

In step S304, in response to verifying the status data being trusted status data, content data is extracted from the status data. To ensure the reliability of data collected by sensor nodes, it is necessary to verify whether the status data is trusted or not. In the embodiments of the present invention, various techniques may be leveraged for verification. For example, a unique identifier may be assigned to each sensor node in the Internet of Things, so as to ensure the sensor node hardware itself is trusted. For another example, while ensuring the sensor node hardware itself is secure and reliable, specific applications may be deployed to monitor the reliability of an operating system and data collecting program that are running on the sensor node, so as to ensure raw data being collected is reliable. In one embodiment of the present invention, for example, Trusted Platform Module (TPM) may be leveraged to protect sensor nodes from illegal access and modification. Those skilled in the art may configure the Trusted Platform Module, depending on specific demands of an application environment. This is not detailed in the context of the present invention.

After it is confirmed the status data from the sensor node is trusted status data, content data may be extracted from the status data. In this embodiment, the content data may refer to data collected by the sensor node and packaged in the status data, such as {temperature, humidity, atmospheric pressure} collected at different time points as illustrated in Table 1 above.

In step S306, the content data is aggregated based on a predefined rule. In the embodiments of the present invention, aggregation may refer to various processing on the content data. The predefined rule may comprise content in various respects. For example, based on the content data that has been acquired within a certain time period, the maximum, minimum, mean and other relevant data of the collected data may be obtained, or the content data may be subjected to other desired processing such as sorting. In various embodiments of the present invention, the predefined rule is used for defining input and output data of the “aggregated” processing as well as mapping relationships between input and output data. For example, this may be implemented in the form of a function in programming language.

Note in one embodiment of the present invention, it is not specially limited that all content data needs to be processed for obtaining a final result, but content data from a specific range of sensor nodes may be processed according to a predefined rule (e.g., according to physical locations of sensor nodes). For example, in the case that 1000 temperature sensors are deployed in the Internet of Things, suppose every 100 sensors are grouped into one group and the data center desires to process data collected by 1000 temperature sensors. At this point, temperature data from each group may be processed first, and then the processed temperature data for 10 groups may be transmitted to the data center.

Finally in step S308, the aggregated content data is transmitted to the data center. In this manner, data processing operations that used to be executed at the data center may be mitigated greatly, and further the load of data traffic in the Internet of Things may be reduced.

Note in this embodiment, the at least one sensor node is connected with the data center via the Internet of Things. For example, middle nodes 230, 232 and communication nodes 234, 236, 238 may be connected by communication network 240 as illustrated in FIG. 2. Those skilled in the art should note the method as illustrated in FIG. 3 may be executed at middle nodes 230 and 232 in communication network 240 as illustrated in FIG. 2.

By means of the method for collecting data in an Internet of Things as illustrated in FIG. 3, the topological structure or hardware configuration of the existing Internet of Things does not need to be modified, but operations that used to be executed by the data center are executed simply by using idle data processing capabilities and storage resources of devices like switches and routers in the existing Internet of Things.

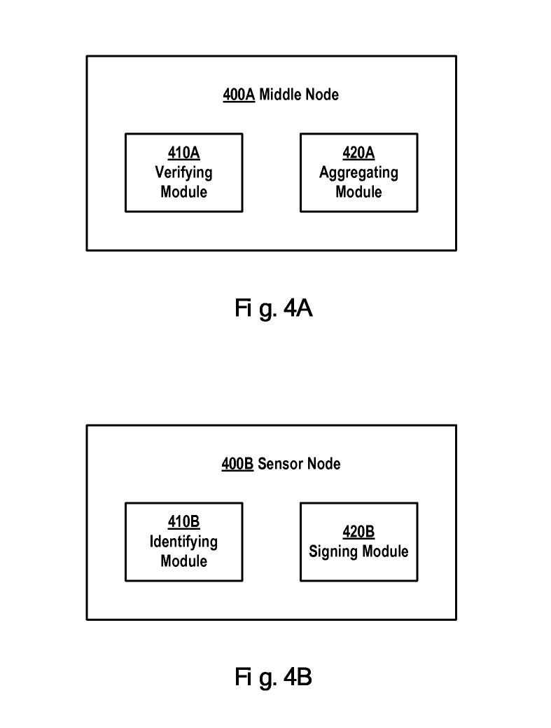

FIGS. 4A and 4B schematically illustrate block diagrams 400A and 400B of a middle node and a sensor node in an Internet of Things according to one embodiment of the present invention, respectively. Those skilled in the art should understand FIGS. 4A and 4B only schematically illustrate an example of modules that may be comprised at the middle node and the sensor node; according to specific demands of an application environment, those skilled in the art may design by themselves modules for executing other functions.

FIG. 4A illustrates a block diagram 400A of a middle node according to one embodiment of the present invention, wherein there are comprised: a verifying module 410A for verifying whether the status data from the sensor node is trusted data or not; and an aggregating module 420A for aggregating, according to a predefined rule, the content data extracted from the status data.

In addition, FIG. 4B illustrates a block diagram 400B of a sensor node according to one embodiment of the present invention, wherein there are comprised: an identifying module 410B for verifying the reliability of hardware and software in the sensor node based on a reliability verification technique (e.g., above-described TPM); and a signing module 420B for signing data collected by the sensor node, so as to ensure the data security during transmission in the Internet of Things. Specifically, the sensor node generates a signature for collected data by using, for example, a public key.

FIG. 5 schematically illustrates a schematic view 500 of the data structure of status data according to one embodiment of the present invention. In this embodiment, the status data may comprise: identification information 510, generated based on Trusted Platform Module in the sensor node for example and for identifying the reliability of a source (i.e., specific sensor node) of status data 500; signature information 520, implemented based on a specific algorithm at the sensor node for example and for verifying whether status data 500 has been falsified during transmission; and content data 530, i.e., specific data collected at the sensor node, e.g., the meteorological data as illustrated in Table 1 above.

Note in one embodiment of the present invention, status data 500 may comprise only identification information 510 and content data 530, whereby the reliability of a data source can be ensured. Signature information 520 functions to verify whether status data 500 has been falsified during transmission. As an optional configuration, signature information 520 may further enhance the security of data transmission procedure in the Internet of Things. Additionally, in one embodiment of the present invention, considering the data transmission efficiency, not all status data needs to be processed for generating signature data, but only a portion (e.g., 1%) of status data may comprise signature information randomly. In this manner, a basis for verifying the security during data transmission can be provided while real-time transmission is ensured.

Those skilled in the art should understand the verifying the reliability of the status data may comprise two aspects of factors, i.e., verifying whether a source (i.e., sensor node) of the status data is reliable or not, and verifying whether the status data has been falsified during transmission. Hereinafter, illustration is given to how to conduct verification based on these two aspects.

In one embodiment of the present invention, the verifying the status data being trusted status data comprises: interpreting identification information in the status data; and in response to the identification information indicating the sensor node is an authenticated device, verifying the status data being trusted status data.

In the embodiment of using the data structure of status data 500 as illustrated in FIG. 5 above, identification information 510 may be obtained from the status data, and subsequently it is verified whether or not the identification information indicates the sensor node is an authenticated device. For example, a unique identifier may be allocated to each authenticated sensor device; upon detecting that identification information 510 comprised in status data 500 belongs to identifiers allocated to authenticated devices, it is considered that status data 500 is trusted status data. In one embodiment of the present invention, identification information 510 in status data 500 may be unencrypted plaintext. In another embodiment of the present invention, identification information 510 may be encrypted in order to further improve the data security. According to specific demands of an application environment, those skilled in the art may further use other approaches to implementing the step of verifying the status data.

In one embodiment of the present invention, the verifying the status data being trusted status data further comprises: interpreting signature information in the status data; and in response to the signature information indicating the status data having not been modified during transmission, verifying the status data being trusted status data.

In the embodiment of using the data structure of status data 500 as illustrated in FIG. 5 above, identification information 520 may be obtained from the status data, for verifying whether or not received status data 500 is falsified during transmission. Based on specific demands of an application environment, those skilled in the art may design by themselves specific methods for verifying signature information 520.

In one embodiment of the present invention, the status data is collected by a sensor node of the at least one sensor node based on a format template. In this embodiment, a format template may be stored in the sensor node, which format template may be pre-disposed at the sensor node together with an operating system. Those skilled in the art should note one or more format templates may be maintained at the sensor node, and the one or more format templates may define, separately or in conjunction, which datum or data is to be collected at which time.

In one embodiment of the present invention, the format template comprises at least: collected objects and triggering events. A triggering event may describe in which case a collection action is triggered. For example, a collection action is triggered at specific intervals, or a collection action is triggered upon monitoring the occurrence of a specific event (e.g., taking pictures when discovering cars run the red light). For example, for a multi-function sensor for monitoring meteorological data, a format template as illustrated in Table 2 below may be used. The format template indicates that temperature, humidity and atmospheric pressure are collected with the frequency of once per second.

TABLE 2
Example of Format Template

| Triggering Event | Once Per Second |
|---|---|
| collect object 1 | temperature |
| collect object 2 | humidity |
| collect object 3 | atmospheric pressure |

Or the format template may be defined in the form of a one-dimensional table, such as <triggering event, once per second>, <temperature, value 1>, <humidity, value 2>, <atmospheric pressure, value 3>. In addition, those skilled in the art may specify in the format template in which format the collected data is saved. For example, it is specified that the collected temperature data is denoted with 16 bits; the collected humidity data is denoted with 8 bits, etc.

In one embodiment of the present invention, there is further comprised: in response to receipt of a first command from the data center, notifying the at least one sensor node to update the format template.

Here the first command may be a command indicating the data center instructs various sensor nodes to update the format template, and the command may comprise, for example, the number (or other unique identifier) of a sensor needing to update the format template, and a new format template. For example, suppose a current sensor collects temperature and humidity data with the frequency of once per minute, by sending to corresponding sensors the format template as illustrated in Table 2 above, various sensors are instructed to collect temperature, humidity and atmospheric pressure data with the frequency of once per second.

In one embodiment of the present invention, the aggregating the content data based on a predefined rule comprises: executing a distributed data processing algorithm with respect to the data content. Those skilled in the art should understand the distributed data processing algorithm here may be, for example, a parallel processing method implemented based on Message Passing Interface. By executing the distributed data processing algorithm at various nodes with computing capabilities in the Internet of Things, it is possible to efficiently utilize potential computing resources of the Internet of Things.

In one embodiment of the present invention, the distributed data processing algorithm may comprise executing Map and/or Reduce operations on the content data. MapReduce is a software framework for parallelizable operations on huge datasets. The concepts “Map” and “Reduce” are derived from functional programming language and vector programming language. The framework specifies one Map operation for mapping a group of key-value pairs to a group of new key-value pairs and specifies a concurrent Reduce operation for ensuring each of all mapped key-value pairs shares the same key group. In one embodiment of the present invention, by executing Map and/or Reduce operations on the content data, each node in the Internet of Things may be leveraged to execute a parallel operation.

In one embodiment of the present invention, there is further comprised: in response to receipt of a second command from the data center, updating the predefined rule.

In this embodiment, the second command may be a command instructing that the rule on which the aggregation is based is modified. For example, the command may comprise the number (or other unique identifier) of a middle node needing to update the rule and a new rule. For example, suppose the current rule which various middle nodes follow is to calculate the maximum of temperature collected by multiple sensor nodes; by sending to each middle node a command containing calculation of the mean, various middle nodes may be instructed to calculate the mean of temperature collected by multiple sensor nodes.

In one embodiment of the present invention, the method is executed at a communication node in the Internet of Things. As communication nodes that are logically close to the data center usually have stronger data processing capabilities and larger storage space, the method as recited in the present invention may be executed at communication nodes that are at a distance of one “hop” to two “hops” from the data center of the Internet of Things.

Those skilled in the art should note in the embodiments of the present invention, various steps of the method as recited in the present invention can be implemented simply by updating software applications of communication nodes in the Internet of Things and then using their idle data processing capabilities and storage space of those communication nodes, without changing physical devices of those communication nodes.

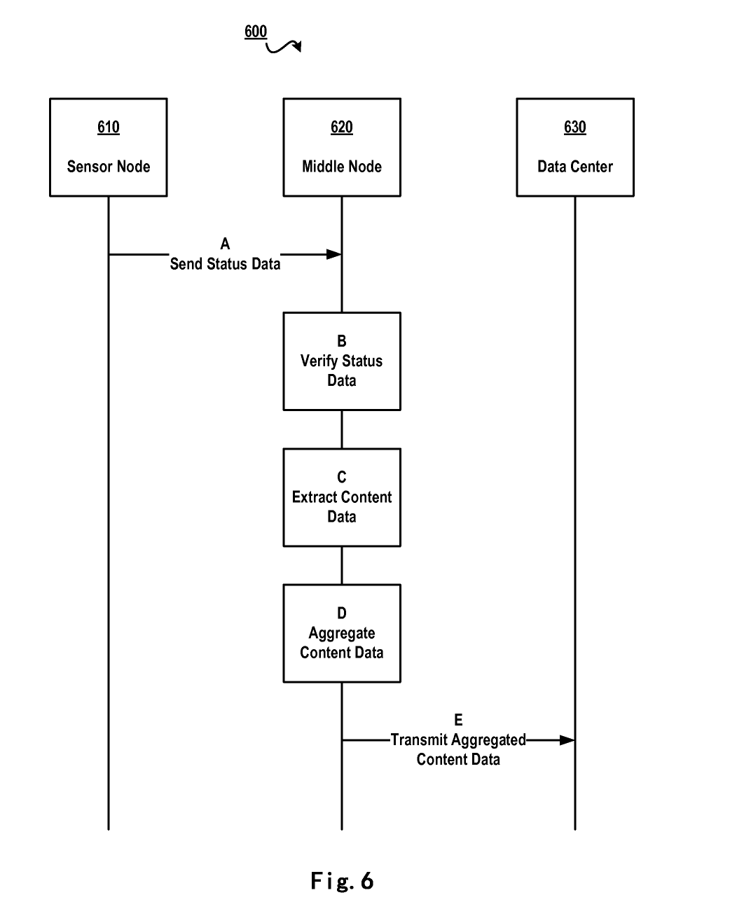

FIG. 6 schematically illustrates a flowchart 600 of collecting data in an Internet of Things. As illustrated in FIG. 6, a sensor node 610 is responsible for collecting data and sending status data to a middle node 620 directly or indirectly (as illustrated by step A). Next, middle node 620 can verify whether the status data is reliable or not (as illustrated by step B), for example, by verifying identification information and/or signature information comprised in the status data. When the status data is trusted status data, content data can be extracted from the status data (as illustrated by step C), and subsequently the extracted content data is aggregated in step D. Finally, in step E, middle node 620 can transmit the aggregated content data to a data center 630.

In this manner, by modifying software applications at sensor node 610 and middle node 620, data collection can be implemented in a real-time, reliable and secure way without changing hardware devices of the Internet of Things. Moreover, operations that used to be executed by data center 630 are executed using idle resources in middle node 620 on the premise of not impairing the real time performance.

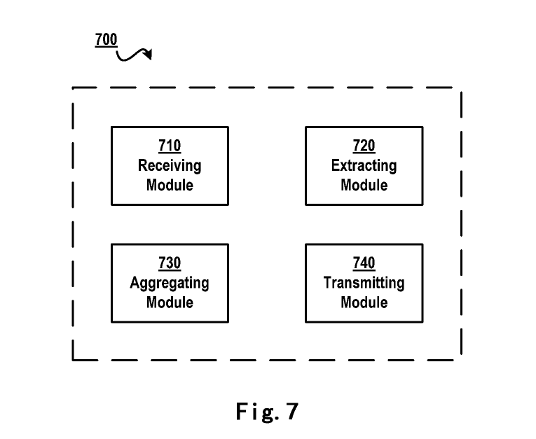

FIG. 7 schematically illustrates a schematic view 700 of an apparatus for collecting data in an Internet of Things according to one embodiment of the present invention. Specifically, FIG. 7 illustrates an apparatus for collecting data in an Internet of Things, comprising: a receiving module 710 configured to receive status data from a sensor node of at least one sensor node; an extracting module 720 configured to, in response to verifying the status data being trusted status data, extract content data from the status data; an aggregating module 730 configured to aggregate the content data based on a predefined rule; and a transmitting module 740 configured to transmit the aggregated content data to a data center; wherein the at least one sensor node is connected with the data center via the Internet of Things.

In one embodiment of the present invention, extracting module 720 comprises: a first interpreting module configured to interpret identification information in the status data; and a first verifying module configured to, in response to the identification information indicating the sensor node is an authenticated device, verify the status data being trusted status data.

In one embodiment of the present invention, extracting module 720 further comprises: a second interpreting module configured to interpret signature information in the status data; and a second verifying module configured to, in response to the signature information indicating the status data having not been modified during transmission, verify the status data being trusted status data.

In one embodiment of the present invention, the status data is collected by a sensor node of the at least one sensor node based on a format template.

In one embodiment of the present invention, there is further comprised: a notifying module configured to, in response to receipt of a first command from the data center, notify the at least one sensor node to update the format template.

In one embodiment of the present invention, the format template comprises at least: collected objects and triggering events.

In one embodiment of the present invention, the aggregating module comprises: executing a distributed data processing algorithm with respect to the data content.

In one embodiment of the present invention, there is further comprised: an updating module configured to, in response to receipt of a second command from the data center, update the predefined rule.

In one embodiment of the present invention, the apparatus is executed at a communication node in the Internet of Things.

In one embodiment of the present invention, there is provided a system for collecting data in an Internet of Things, comprising: at least one sensor node configured to collect status data in the Internet of Things; a data center configured to manage the Internet of Things; and a middle node configured to: receive the status data from a sensor node of the at least one sensor node; in response to verifying the status data being trusted status data, extract content data from the status data; aggregate the content data based on a predefined rule; and transmit the aggregated content data to the data center; wherein the at least one sensor node is connected with the data center via the middle node.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for collecting data in an Internet of Things, the method comprising:
receiving status data from at least one sensor node;
extracting content data from the status data received from the at least one sensor node;
aggregating the content data; and
transmitting the aggregated content data to a data center.

2. The method as claimed in claim 1, wherein content data is extracted from the status data in response to verifying that the status data from the at least one sensor node is a trusted source.

3. The method as claimed in claim 1, wherein the at least one sensor is coupled with the data center via Internet of Things.

4. The method as claimed in claim 2, wherein verifying the status data further comprises:
interpreting an identification information in the status data thereby indicating the sensor node is an authenticated device.

5. The method as claimed in claim 2, wherein verifying the status data further comprises:
interpreting a signature information in the status data, wherein the signature information indicating that the status data is not modified during transmission.

6. The method as claimed in claim 1, wherein the status data is collected by the at least one sensor node based on a format template.

7. The method as claimed in claim 6, further comprising:
notifying the at least one sensor node to update the format template in response to receipt of a first command from the data center.

8. The method as claimed in claim 6, wherein the format template comprises at least one of collected objects and triggering events.

9. The method as claimed in claim 1, wherein the aggregating the content data based on a set of predefined rule.

10. The method as claimed in claim 1, wherein a communication node interfaces the at least one sensor and the data center in the Internet of Things for transmission of the aggregated content data.

11. An apparatus for collecting data in an Internet of Things, comprising:
a receiving module configured to receive status data from a sensor node of at least one sensor node;
an extracting module configured to, in response to verifying the status data being trusted status data, extract content data from the status data;
an aggregating module configured to aggregate the content data based on a predefined rule; and
a transmitting module configured to transmit the aggregated content data to a data center;
wherein the at least one sensor node is connected with the data center via the Internet of Things.

12. The apparatus according to claim 11, wherein the extracting module comprises:
a first interpreting module configured to interpret identification information in the status data; and
a first verifying module configured to, in response to the identification information indicating the sensor node is an authenticated device, verify the status data being trusted status data.

13. The apparatus according to claim 12, wherein the extracting module further comprises:
a second interpreting module configured to interpret signature information in the status data; and
a second verifying module configured to, in response to the signature information indicating the status data having not been modified during transmission, verify the status data being trusted status data.

14. The apparatus according to claim 11, wherein:
the status data is collected by a sensor node of the at least one sensor node based on a format template.

15. The apparatus according to claim 14, further comprising:
a notifying module configured to, in response to receipt of a first command from the data center, notify the at least one sensor node to update the format template.

16. The apparatus according to claim 14, wherein the format template comprises at least: collected objects and triggering events.

17. The apparatus according to claim 11, wherein the aggregating module comprises: executing a distributed data processing algorithm with respect to the data content.

18. The apparatus according to claim 11, further comprising:
an updating module configured to, in response to receipt of a second command from the data center, update the predefined rule.

19. The apparatus according to claim 11, wherein the apparatus is executed at a communication node in the Internet of Things.

20. A system for collecting data in an Internet of Things, comprising:
at least one sensor node configured to collect status data in the Internet of Things;
a data center configured to manage the Internet of Things; and
a middle node configured to:
receive the status data from a sensor node of the at least one sensor node;
in response to verifying the status data being trusted status data, extract content data from the status data;
aggregate the content data based on a predefined rule; and
transmit the aggregated content data to the data center;
wherein the at least one sensor node is connected with the data center via the middle node.
